(19) United States
(12) Patent Application Publication
(10) Pub. No.: US 2004/0109446 A1
(43) Pub. Date: Jun. 10, 2004

(54) Calling method and system of flexible IP internet phone

(75) Inventor: Seog-Bae Heo, Suwon (KR)

Correspondence Address: Daniel Y.J. Kim, FLESHNER & KIM, LLP, P.O. Box 221200, Chantilly, VA, 20153-1200, US

(73) Assignee: LG Electronics Inc.

(21) Appl. No.: 10/622,429

(22) Filed: Jul. 21, 2003

(30) Foreign Application Priority Data
Jul. 22, 2002 (KR) 42965/2002

(51) Int. Cl. H04L 12/56

(52) U.S. Cl. 370/389

(57) ABSTRACT

A system and method for placing and receiving calls using a flexible IP Internet phone is disclosed. The method preferably includes allocating IP addresses respectively to a plurality of flexible IP Internet phones connecting to an Internet network, registering the IP address allocated to the flexible IP Internet phone in the IP storing server, extracting the IP address of another flexible IP Internet phone to be called by the flexible IP Internet phone or the fixed IP Internet phone, and connecting to the extracted IP address to make the call. Therefore, users of the flexible IP Internet phones are able to make/receive calls using the Internet.

### BACKGROUND OF THE INVENTION

1. Field of the Invention

The present invention relates to a calling system and method of a flexible IP Internet phone, and more particularly to a calling method of a flexible IP Internet phone by which a user having the flexible IP Internet phone is able to receive a call.

2. Background of the Related Art

Recently, the Internet has rapidly become widely available and has become a part of life. The number of users using the Internet has also rapidly increased and requirements for various services have been raised.

Especially, usage of Internet phones, by which a call can be made with a remote counterpart through an Internet network, has rapidly increased. The Internet phone can make a call using an IP address, and therefore a long-distance call or an international call can be made inexpensively through the Internet.

The IP address is an address of 32 bits granted in order to perform a routing effectively on the Internet. The concept the IP address is similar to that of a physical network address. An IP address cannot be allocated to all of the users who want to be allocated an IP addresses with the 32-bit address system of IPv4 that is presently used. Therefore, an Internet service provider (ISP) may provide a flexible IP service that allocates an IP address whenever the user requires a connection through the Internet phone with a constant IP address.

FIG. 1 is a block diagram showing a configuration of an Internet phone system according to the related art.

As shown therein, the Internet phone system includes a plurality of flexible IP Internet phones 10, a plurality of fixed IP Internet phones 11, and an Internet service provider 12 providing a connecting service so that users of the S Internet phone can make a call to users of other Internet phone.

An operation of the Internet phone system configured as above will be described as follows.

When a user of a fixed IP Internet phone 11 tries to connect a call with a user of a second fixed IP Internet phone, the user of the fixed IP Internet phone 11 calls the user of the second fixed IP Internet phone through an Internet service provider 12. At that time, since the IP address of the fixed IP Internet phone user is fixed, the call with the other fixed IP Internet phone user can be made using the IP address allocated to the corresponding Internet phone.

The related art system and method has various problems. For example, when a user of a flexible IP Internet phone 10 or the user of the fixed IP Internet phone 11 tries to make a call with the user of another flexible IP Internet phone 10, the IP address of the flexible IP Internet phone 10 is not known, since it is changed whenever the flexible IP Internet phone connects to the Internet. Therefore, the call cannot be made even with a counterpart to whom the call was made previously.

As described above, the user of the flexible IP Internet phone 10 uses the telephone service after being allocated a new IP address from the Internet service provider whenever he/she connects to the Internet in the related art Internet phone system. Therefore, the user is able to make a call with the new IP address, but is not able to receive a call since the counterpart does not know the changed IP address.

Also, in order for the Internet phone user to be allocated the fixed IP address to make the call freely in the related art Internet phone system, a higher price than that of the flexible IP must be paid.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

Another object of the present invention is to provide a system and method of a flexible IP Internet phone by which a call can be made/received by a user of a flexible IP Internet phone by connecting to the Internet.

To achieve at least the above objects, in whole or in parts, there is provided a calling method of a flexible Internet phone in an Internet phone system providing a service so as to make a call between a plurality of flexible IP Internet phones and fixed IP Internet phone including registering IP addresses allocated to the respective flexible IP Internet phones in an IP storing server, and extracting corresponding IP address when a call with the flexible IP Internet phone is required.

To further achieve the objects in whole or in parts, there is provided a calling method of a flexible IP Internet phone, including allocating IP addresses respectively to a plurality of flexible IP Internet phones connected to Internet network, storing the IP addresses allocated to the respective flexible IP Internet phones in a storing server, extracting the IP address of another IP Internet phone to which the flexible IP Internet phone or a fixed IP Internet phone tries to make a call, and performing a call by connecting to the extracted IP address.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a block diagram showing a configuration of a related art Internet phone system;

FIG. 2 is a block diagram showing a configuration of an Internet phone system according to a preferred embodiment of the present invention;

FIG. 3 is a view showing a table of an IP storing server according to a preferred embodiment of the present invention;

FIG. 4 is a flow chart illustrating a calling method of a flexible IP Internet phone according to a preferred embodiment of the present invention; and

FIG. 5 is a flow chart illustrating a case where a call is made between flexible IP Internet phones according to a preferred embodiment of the present invention.

### DETAILED DESCRIPTION OF PREFERRED EMBODIMENTS

Reference will now be made in detail to the preferred embodiments of the present invention, examples of which are illustrated in the accompanying drawings.

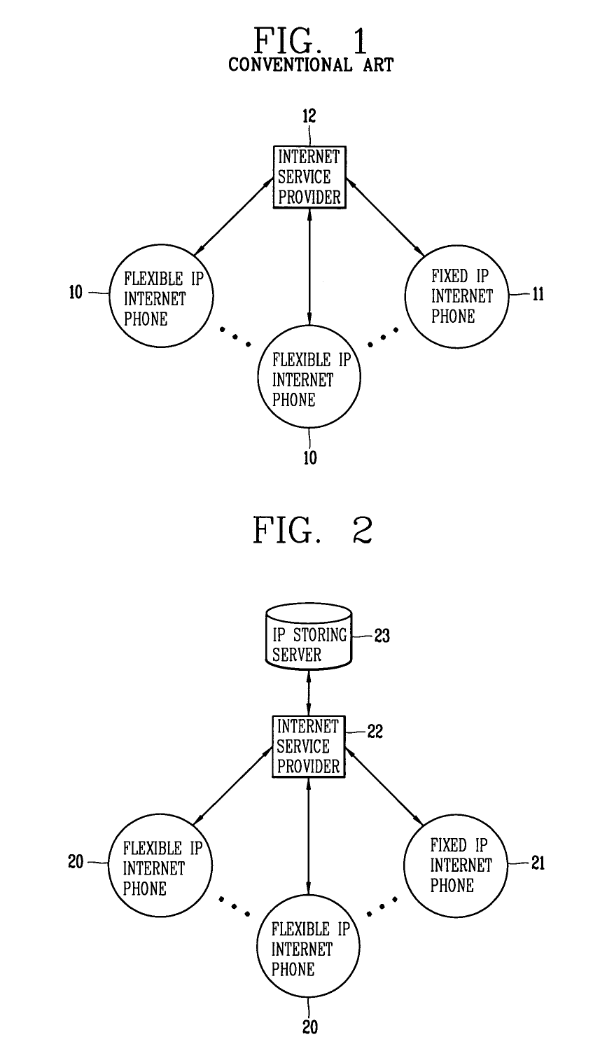

FIG. 2 is a drawing showing a configuration of an Internet phone system according to a preferred embodiment of the present invention. As shown therein, the Internet phone system preferably includes a plurality of flexible IP Internet phones 20, which are allocated new IP addresses whenever they connect to the Internet, and a plurality of fixed IP Internet phones 21. The system preferably also includes an Internet service provider 22 to provide a service so that users of the Internet phones can make calls, and an IP storing server 23 for storing IP addresses allocated to the flexible IP Internet phones.

The flexible IP Internet phone 20 is preferably allocated a new IP address from the 10 Internet service provider 22 whenever it connects to the Internet to make a call. The allocated IP address is then preferably registered in the IP storing server 23. At that time, the flexible IP Internet phone registers the newly allocated IP address in the IP storing server 23 whenever the IP address is changed.

The IP storing server 23 preferably receives and stores the IP address along with a terminal generic number of the flexible IP Internet phone 20, which is received from the flexible IP Internet phone 20. The terminal generic number is a media access control (C) address allocated to the flexible IP Internet phone 20, and is a fixed value set as the generic number in every terminal.

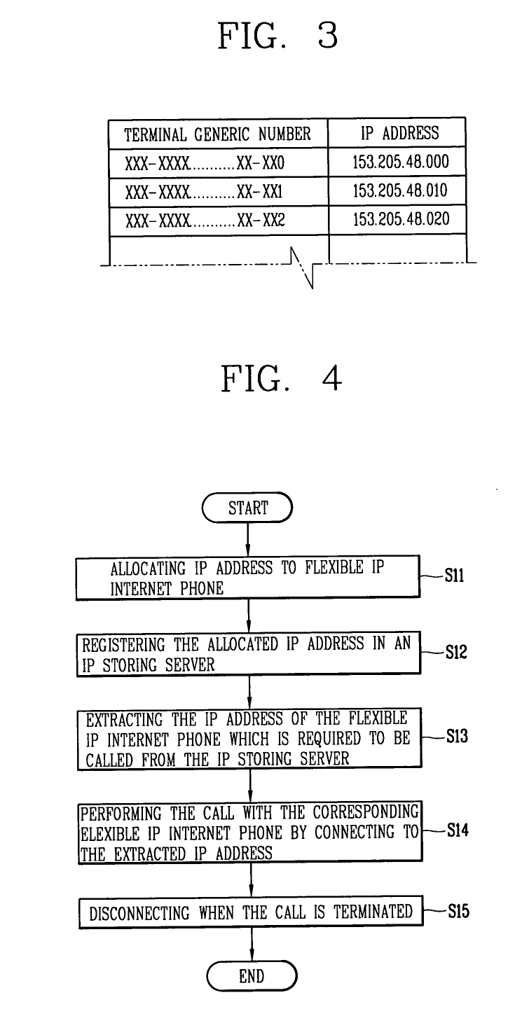

FIG. 3 is a drawing illustrating a table in which the IP addresses and the corresponding terminal generic 20 numbers are preferably stored in the IP storing server.

When the IP storing server 23 receives the terminal generic number and the presently allocated IP address from the flexible IP Internet phone 20, the IP storing server 23 searches the block corresponding to the terminal generic number in the table shown in FIG. 3. After that, the IP storing server 23 replaces the IP address stored in the corresponding block with the presently received IP address. The new information is thus stored. It should be understood that if the terminal generic number is not found in the table, then a new record is created to store the current IP address and the associated terminal generic number.

That is, the IP storing server 23 stores the IP address after updating the changed IP address whenever the IP address allocated to the flexible IP Internet phone 20 is changed. Therefore, the IP storing server 23 preferably always stores the current IP address of the flexible IP Internet phone.

When the IP storing server 23 receives a call request with a target flexible IP Internet phone 20 from a flexible IP Internet phone 20 or from a fixed IP Internet phone 21, the IP address of the corresponding target flexible IP Internet phone is extracted and the IP address is transmitted to the flexible IP Internet phone 20 or to the fixed IP Internet phone 21 which transmits the call request.

FIG. 4 is a flow chart illustrating a calling method of the flexible IP Internet phone according to a preferred embodiment of the present invention. The method is applicable to a case where a call to a target flexible IP Internet phone is made through either a flexible IP Internet phone or a fixed IP Internet phone.

Referring to FIG. 4, when a flexible IP Internet phone connects to the Internet, the Internet service provider preferably allocates an IP address to the flexible IP Internet phone (step S11). The flexible IP Internet phone then preferably registers the IP address allocated from the Internet service provider in the IP storing server (step S12).

Specifically, the flexible IP Internet phone connects to the IP storing server to update the IP address whenever the IP address is changed.

When a flexible IP Internet phone or of a fixed IP Internet phone tries to make a call to a target flexible IP Internet phone, the flexible IP Internet phone or the fixed IP Internet phone placing the call preferably accesses the IP storing server through the Internet service provider to extract the present IP address of the flexible IP Internet phone to which the call is placed (step S13).

The flexible IP Internet phone or the fixed IP Internet phone placing the call then connects to the IP address extracted from the IP server to perform the call with the target flexible IP Internet phone (step S14). When the call is terminated, the connection with the corresponding flexible IP Internet phone is released (step S15).

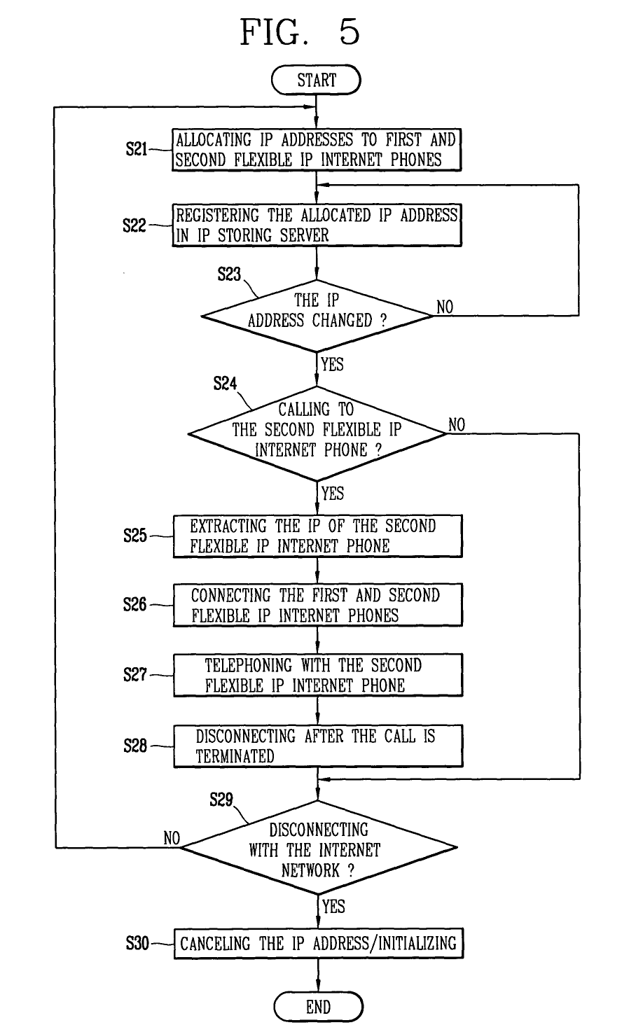

FIG. 5 is a flow chart illustrating a case where a call is made between flexible IP Internet phones according to the preferred embodiment. The process of telephoning between the flexible IP Internet phone with another flexible IP Internet phone will be described in more detail as follows.

As shown in FIG. 5, each flexible IP Internet phone connecting to the Internet is preferably allocated an individual IP address from the Internet service provider (step S21). That is, when the first flexible IP Internet phone and the second flexible IP Internet phone connect to the Internet, the Internet service provider providing the Internet phone service allocates the IP addresses to the respective flexible IP Internet phones.

Next, the first and second flexible IP Internet phones, having been allocated the IP addresses 15 from the Internet phone service provider, preferably register the corresponding IP addresses in the IP storing server (step S22). The IP storing server preferably stores the IP address received from the first and second flexible IP Internet phones with the fixed terminal generic numbers allocated to the respective Internet phones. Therefore, these are used as a reference for searching the block in which the IP address of the corresponding IP Internet phone is stored.

The first and second flexible IP Internet phones preferably automatically update/register the changed IP address in the IP storing server whenever the IP address is changed, for example due to communication environment or various additional factors (step S23).

If it is determined that the user of the first flexible IP Internet phone wants to make a call with the user of the second flexible IP Internet phone (step S24), the first flexible IP Internet phone extracts the IP address of the second flexible IP Internet phone stored in the IP storing server (step S25).

The first flexible IP Internet phone attempts to connect to the second flexible IP Internet phone using the extracted IP address (step S26), and establishes the call with the user of the second flexible IP Internet phone when the connection is made (step S27).

When the call between the users of the first and second flexible IP Internet phones ends, the connection between the first and second flexible IP Internet phones is released (step S28). It is subsequently determined whether the connection of the first or the second flexible IP Internet phone to the Internet is disconnected (step S29).

When either or both of the first or the second IP Internet phone is disconnected from the Internet, the allocated IP address to the disconnected IP Internet phone is canceled to return the initialized status (step S30). When, however, either or both of the first or the second IP Internet phone is not disconnected from the Internet network, a new IP address is preferably allocated to the phone from the Internet service provider (step S21), and the new address is updated and registered in the IP storing server. After that, the operation of the Internet phone is changed to stand-by status. It should be noted that the same IP address could be reallocated to the IP Internet phone.

According to the calling method and system of the flexible IP Internet phone of the preferred embodiments of the present invention, users of flexible IP Internet phones that do not have a fixed IP address are able to make and receive calls during a connection to the Internet.

Also, according to the preferred embodiments of the present invention, the flexible IP allocated to the flexible IP Internet phone can be used as a fixed IP. Therefore, the cost to be allocated the fixed IP can be reduced and the convenience of the user can be improved.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A calling method of a flexible IP Internet phone in an Internet phone system providing Internet communication service, comprising:
registering an IP address allocated to a flexible IP Internet phone in an IP storing server; and
extracting the IP address when a call with the flexible IP Internet phone is required.

2. The method of claim 1, wherein registering the IP address comprises:
receiving an IP address allocation from an Internet service provider by connecting the flexible IP Internet phone to the Internet; and
storing the allocated IP address in the IP storing server along with an identification number of the flexible IP Internet phone.

3. The method of claim 1, wherein the allocated IP address is associated with a terminal number of the flexible IP Internet phone in a database of the IP storing server.

4. The method of claim 1, wherein extracting the IP address comprises:
generating a call requirement in a calling IP Internet phone to the flexible IP Internet phone; and
extracting the IP address of the flexible IP Internet phone from the IP storing server.

5. The method of claim 4, wherein the calling IP Internet phone is one of a fixed IP Internet phone and another flexible IP Internet phone.

6. The method of claim 1, wherein the IP storing server updates and stores the IP address whenever the IP address of the flexible IP Internet phone is changed.

7. The method of claim 1, wherein the IP storing server is configured to store a terminal generic number and the IP address transmitted from the flexible IP Internet phone in a table form.

8. A calling method of a flexible IP Internet phone, comprising:
allocating an IP address to a flexible IP Internet phone connected to an Internet network;
registering the IP address allocated to the flexible IP Internet phone in an IP storing server;
extracting the IP address of the flexible IP Internet phone by one of a calling flexible IP Internet phone and a calling fixed IP Internet phone; and
connecting to the flexible IP Internet phone using extracted IP address.

9. The method of claim 8, further comprising allocating a new IP address to the flexible IP Internet phone when the call with the flexible IP Internet phone ends.

10. The method of claim 8, wherein the IP storing server is configured to store a terminal generic number and the IP address transmitted from the flexible IP Internet phone in a table form.

11. The method of claim 10, wherein the terminal generic number is a reference used to locate the IP address in the IP storing server.

12. The method of claim 8, wherein the IP storing server updates and stores the IP address whenever the IP address of the flexible IP Internet phone is changed.

13. A method of performing IP Internet communication, comprising:
receiving an allocation of an IP address from Internet service provider (ISP) by a flexible IP Internet phone when the flexible IP Internet phone connects to the ISP; and
storing the allocated IP address in a data table of a storing server along with a terminal number of the flexible IP Internet phone, wherein the data table is configured to receive a query including the terminal number of the flexible IP Internet phone and return the associated IP address in response to the query.

14. The method of claim 13, further comprising receiving an incoming call to the flexible IP Internet phone by a calling party that has identified the IP address of the flexible IP phone from a query to the data table.

15. A method of calling a target flexible IP Internet phone having no fixed IP address, comprising:
searching a database having stored therein a current IP address associated with a terminal number of the target flexible IP Internet phone;
retrieving the IP address assigned to the target flexible IP Internet phone; and
establishing communication to the target flexible IP Internet phone using the retrieved IP address.

16. The method of claim 15, wherein the IP address is assigned to the target flexible IP Internet phone by an Internet service provider (ISP) when the flexible IP Internet phone connects to the ISP.

17. An Internet protocol (IP) communication system, comprising:
at least one flexible IP Internet phone having a terminal number;
an Internet service provider (ISP) configured to assign a current IP address to the at least one flexible IP Internet phone when the at least one flexible IP Internet phone connects to the ISP; and
an IP storing server configured to store a table of data associating the terminal number of the at least one flexible IP Internet phone with the assigned IP address.

18. The system of claim 17, further comprising at least one second IP Internet phone, configured to search the IP storing server to determine the current IP address of the at least one flexible IP Internet phone to establish communication with the at least one flexible IP Internet phone.

19. The system of claim 18, wherein the at least one second IP Internet phone is one of a fixed IP Internet phone and a flexible IP Internet phone.

20. The system of claim 18, wherein the at least one flexible IP Internet phone is configured to provide the current IP address and the terminal number to the IP storing server when the ISP assigns the current IP address.
